(19) United States
(12) Patent Application Publication
(10) Pub. No.: US 2020/0021174 A1
(43) Pub. Date: Jan. 16, 2020

(54) AXIAL MOTOR FOR TRACTION MACHINE AND APPARATUS FOR FABRICATING STATOR CORE THEREOF

(71) Applicant: NAWOOTEC CO., LTD., Incheon (KR)

(72) Inventor: Jeung Woo LEE, Incheon (KR)

(21) Appl. No.: 16/236,788

(22) Filed: Dec. 31, 2018

(30) Foreign Application Priority Data
Jul. 10, 2018 (KR) 10-2018-0079999

(51) Int. Cl. H02K 15/02; H02K 1/16; H02K 21/24

(52) U.S. Cl. CPC H02K 15/024; B21B 37/46; H02K 21/24; H02K 1/16

(57) ABSTRACT

An axial motor for a traction machine and an apparatus for fabricating a stator core thereof is fabricated by rolling a thin plate having open slots such that turns of the thin plate are stacked on each other. The outer circumferential surface of the thin plate is pressed using a pressing roller while the thin plate is being rolled. The thin plate is not deformed by tension, the open slots aligned in positions are accurately maintained, and the thin plate is prevented from being loose, thereby significantly lowering a defect ratio in fabrication, lowering fabrication costs, and fabricating a high-quality product.

### CROSS REFERENCE TO RELATED APPLICATION

The present application claims priority to Korean Patent Application Number 10-2018-0079999 filed on Jul. 10, 2018, the entire contents of which are incorporated herein for all purposes by this reference.

### BACKGROUND

### Field

The present disclosure relates to an axial motor for a traction machine and an apparatus for fabricating a stator core thereof. More particularly, the present disclosure relates to an apparatus for fabricating a stator core of an axial motor for a traction machine by rolling a thin plate having open slots such that turns of the thin plate are stacked on each other. The outer circumferential surface of the thin plate is pressed using a pressing roller while the thin plate is being rolled. It is possible to prevent the thin plate from being deformed by tension, accurately maintain the open slots aligned in positions, and prevent the thin plate from being loose during rolling of the thin plate, thereby significantly lowering a defect ratio in fabrication, lowering fabrication costs, and fabricating a high-quality product. It is possible to adjust the wound state of the thin plate by controlling the speed of a winding roller while rolling the thin plate, so that the open slots can be accurately maintained in aligned positions and the process can be performed more rapidly.

### Description

In general, in the age of skyscrapers, elevators are essential apparatuses, with the use and competitiveness thereof continuously increasing. Elevators are developing into a variety of shapes, among which an elevator without a machine room has recently attracted a significant degree of interest, as a representative example of a space saving elevator.

A miniaturized traction machine may be essential for the realization of an elevator without a machine room. In such a miniaturized traction machine, the use of an axial motor is more advantageous than the use of a radial motor, since it may be easier to obtain sufficient space for an axial motor to be accommodated and a relatively small axial motor can generate a relatively large amount of power, due to high power density thereof.

Such a radial motor may have a structure in which a rotor and a stator are arranged in the radial direction of a rotary shaft. In contrast, the axial motor may have a structure in which a rotor and a stator are linearly arranged in the direction of a rotary shaft, thereby enabling the axial motor to be slimmed, which is more advantageous.

At present, no mass production of elevator traction machines using an axial motor has been carried out. The research and development of traction machines using an axial motor are underway by a multitude of companies and institutes. However, no satisfactory fabrication method or apparatus for an axial motor has yet been developed, since it is difficult to fabricate such an axial motor.

FIG. 1 is a perspective view schematically illustrating a typical axial motor, while FIGS. 2 and 3 are perspective views illustrating a related-art method of fabricating a stator core of an axial motor.

As illustrated in FIG. 1, the axial motor includes a disk-shaped rotor core 2 and a disk-shaped stator core 1 disposed on a rotary shaft 3, such that the rotor core 2 and the stator core 1 face each other. The rotor core 2 is mainly implemented using a disk-shaped rotor core including permanent magnets (made of a magnetic material), and the stator core 1 includes a disk-shaped magnetic plate 5 and a plurality of protrusion cores 4 arranged on the magnetic plate 5 in the circumferential direction at predetermined distances from each other. Wire coils (not shown) are wound around the protrusion cores 4 to induce electromagnetic force.

As illustrated in FIG. 2, the stator core 1 may be fabricated by fabricating the protrusion cores 4 in a segmented manner and connecting the protrusion cores 4 to the disk-shaped magnetic plate 5. In this case, the size and shape of the protrusion cores 4 may vary depending on the size and type of the motor. Molds for fabricating the protrusion cores 4 must be fabricated in a large number, e.g. in an amount of tens or hundreds, corresponding to different sizes and types of motor. This consequently may significantly increase fabrication costs, which is problematic.

A method of fabricating the stator core 1 by machining slots in a thin plate and continuously winding the thin plate in the circumferential direction, such that the thin plate is rolled and turns of the thin plate are stacked on each other, so that the protrusion cores 4 alternating with the slots 6 are formed, has been developed to solve this problem. Although this method has advantages, such as relatively easy fabrication and reduced fabrication costs, there may be drawbacks, in that the quality of the stator core may be degraded. That is, a high product defect ratio may be caused in the process of continuously winding the thin plate, since it may be difficult to accurately align the slots 6 in the radial directions. In particular, in the process of winding the thin plate, longitudinal tension may cause deformation in portions of the thin plate adjacent to the slots 6, thereby making it difficult to provide a uniformly wound shape. The shapes of the slots 6 may be distorted in the radial directions. Accordingly, it is significantly difficult to fabricate the stator core.

The information disclosed in the Background section is only provided for a better understanding of the background and should not be taken as an acknowledgment or any form of suggestion that this information forms prior art that would already be known to a person skilled in the art.

### BRIEF SUMMARY

Various aspects of the present disclosure provide an apparatus for fabricating a stator core of an axial motor for a traction machine by rolling a thin plate having open slots such that turns of the thin plate are stacked on each other. The outer circumferential surface of the thin plate is pressed using a pressing roller while the thin plate is being rolled. It is possible to prevent the thin plate from being deformed by tension, accurately maintain the open slots aligned in positions, and prevent the thin plate from being loose during rolling of the thin plate, thereby significantly lowering a defect ratio in fabrication, lowering fabrication costs, and fabricating a high-quality product.

Also provided is an apparatus for fabricating a stator core of an axial motor for a traction machine, in which it is possible to adjust the wound state of the thin plate by controlling the speed of a winding roller while rolling the thin plate, so that the open slots can be accurately maintained in aligned positions and the process can be performed more rapidly.

Also provided is an apparatus for fabricating a stator core of an axial motor for a traction machine, in which it is possible to accurately adjust the rotational speed of the winding roller using a sensor detecting every rotation of the winding roller in order to accurately maintain the open slots of the thin plate in aligned positions, thereby significantly reducing a defect ratio.

Also provided is an apparatus for fabricating a stator core of an axial motor for a traction machine, in which pressing force based on elasticity can help the pressing unit press the outer circumferential surface of the thin plate, so that pressing force based on hydraulic or pneumatic pressure can be complemented. It is possible to buffer an increase in pressure due to the thickness of layers of the rolled thin plate or an impact due to an instantaneous increase in pressure or the like, which may occur during pressed rolling, so that the stator core can more reliably operate.

Also provided is an apparatus for fabricating a stator core of an axial motor for a traction machine, in which a plurality of pressing rollers are arranged in the circumferential direction to press the outer circumferential surface of the thin plate. It is possible to press a plurality of portions of the outer circumferential surface of the thin plate, thereby more completely preventing the thin plate from being deformed.

According to an aspect, provided is an apparatus for fabricating a stator core of an axial motor for a traction machine. The apparatus may include: a supply unit supplying a thin plate made of a metal and wound in a roll; a slot machining unit machining open slots in the thin plate supplied by the supply unit, such that the slots are open toward an edge of the thin plate and are spaced apart from each other in a direction in which the thin plate is supplied; a winding unit receiving the thin plate from the slot machining unit and winding the thin plate around a winding roller such that the thin plate is rolled and turns of the thin plate are stacked on one another; a pressing unit pressing an outer circumferential surface of the thin plate, wound around the winding roller, toward a center of the winding roller; and a controller controlling operations of the supply unit, the slot machining unit, the winding unit, and the pressing unit such that the open slots of the thin plate are aligned in radial directions when the thin plate is wound around the winding roller.

Here, the pressing unit may include: a pressing roller in rolling contact with the outer circumferential surface of the thin plate, which is wound on the winding roller; and a pressurizing device actuated by hydraulic or pneumatic pressure to press the pressing roller in a direction of a center of the winding roller.

In addition, the controller may control an operation of the pressurizing device such that pressing force of the pressurizing device is adjusted in response to increases in the number of turns of the thin plate wound around the winding roller.

Furthermore, the pressurizing device may include: a pressing rod having one end connected to the pressing roller; and a pressurizing cylinder linearly moving the pressing rod using hydraulic or pneumatic pressure supplied by a pressure supply pump.

In addition, the pressurizing device may include: an actuation block linearly movable together with the pressing rod, with one end portion thereof being connected to a rotary shaft of the pressing roller and the other end portion thereof being connected to the pressing rod; and an elastic spring applying elastic force to the actuation block in the direction in which the pressing roller is pressed.

Furthermore, the pressurizing device may be linearly movably disposed such that a distance between the pressing roller and the winding roller is adjustable.

In addition, the pressing roller may include a plurality of pressing rollers. The pressurizing device may further include a roller guide frame to which the plurality of pressing rollers are rotatably coupled, such that the plurality of pressing rollers are coupled to the roller guide frame such that rotary shafts thereof are disposed on a circular line concentric with the winding roller. The pressurizing device may simultaneously pressurize the plurality of pressing rollers via the roller guide frame.

Furthermore, the slot machining unit may form the open slots in the thin plate by machining such that recesses are formed in both sides of the open slots.

The apparatus may further include: a rotation indicator attached to the winding roller to indicate a winding start point of the thin plate; and a rotation sensor provided outside of the winding roller to detect passing of the rotation indicator when the winding roller rotates, wherein the controller receives a detection signal of the rotation sensor and controls the operation of the winding unit so that a rotational speed of the winding roller gradually increases at every rotation of the winding roller.

According to another aspect, provided is a method of fabricating a stator core of an axial motor for a traction machine. The method may include: supplying a thin plate made of a metal and wound in a roll; machining open slots in the thin plate supplied by the supply unit, such that the slots are open toward an edge of the thin plate and are spaced apart from each other in a direction in which the thin plate is supplied; receiving the thin plate having the open slots and winding the thin plate around a winding roller such that the thin plate is rolled and turns of the thin plate are stacked on each other; and pressing an outer circumferential surface of the thin plate, which is wound around the winding roller, toward a center of the winding roller using a pressing roller. The operation of the winding roller may be controlled such that a winding rotational speed of the winding roller gradually increases at every rotation.

According to the present disclosure as set forth above, the apparatus fabricates a stator core of an axial motor for a traction machine by rolling a thin plate having open slots such that turns of the thin plate are stacked on each other. The outer circumferential surface of the thin plate is pressed using a pressing roller while the thin plate is being rolled. It is possible to prevent the thin plate from being deformed by tension, accurately maintain the open slots aligned in positions, and prevent the thin plate from being loose during rolling of the thin plate, thereby significantly lowering a defect ratio in fabrication, lowering fabrication costs, and fabricating a high-quality product.

In addition, it is possible to adjust the wound state of the thin plate by controlling the speed of a winding roller while rolling the thin plate, so that the open slots can be accurately maintained in aligned positions and the process can be performed more rapidly.

Furthermore, it is possible to accurately adjust the rotational speed of the winding roller using a sensor detecting every rotation of the winding roller in order to accurately maintain the open slots of the thin plate in aligned positions, thereby significantly reducing a defect ratio.

In addition, pressing force based on elasticity can help the pressing unit press the outer circumferential surface of the thin plate, so that pressing force based on hydraulic or pneumatic pressure can be complemented. Accordingly, it is possible to buffer an increase in pressure due to the thickness of the layers of the rolled thin plate or an impact due to an instantaneous increase in pressure or the like, which may occur during pressed rolling, so that the stator core can more reliably operate.

Furthermore, the circumferential direction to press the outer circumferential surface of the thin plate. Accordingly, it is possible to press a plurality of portions of the outer circumferential surface of the thin plate, thereby more completely preventing the thin plate from being deformed.

### BRIEF DESCRIPTION OF THE DRAWINGS

The above and other objects, features and advantages of the present disclosure will be more clearly understood from the following detailed description when taken in conjunction with the accompanying drawings, in which:

FIG. 1 is a perspective view schematically illustrating a typical axial motor;

FIGS. 2 and 3 are perspective views illustrating a related-art method of fabricating a stator core of an axial motor;

FIG. 4 is a conceptual view illustrating a configuration of an apparatus for fabricating a stator core of an axial motor for a traction machine according to exemplary embodiments;

FIG. 5 is a perspective view schematically illustrating a configuration of a rolling unit and a pressing unit according to exemplary embodiments;

FIG. 6 is a side view illustrating a wound shape of the thin plate according to exemplary embodiments;

FIG. 7 is a top view illustrating positions of the slots in the thin plate according to exemplary embodiments;

FIG. 8 is a top view illustrating deformations in the thin plate according to exemplary embodiments;

FIG. 9 is a side view schematically illustrating a configuration of an exemplary embodiment of the pressing unit;

FIG. 10 is a side view schematically illustrating a configuration of another exemplary embodiment of the pressing unit; and

FIGS. 11A and 11B are perspective views schematically illustrating a configuration of a stator core fabricated by the fabrication apparatus according to exemplary embodiments.

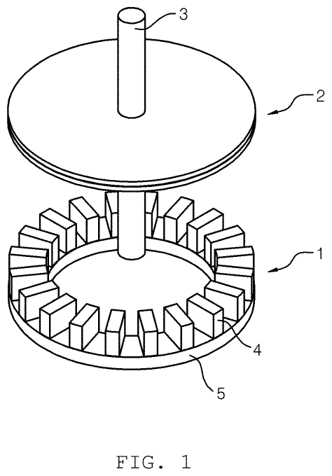

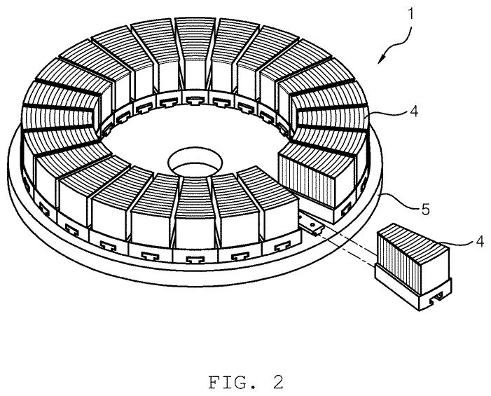

### DETAILED DESCRIPTION

Hereinafter, embodiments of the present disclosure will be described in detail with reference to the accompanying drawings. Throughout this document, reference should be made to the drawings, in which the same reference numerals and symbols will be used to designate the same or like components. In the following description of the present disclosure, detailed descriptions of known functions and components incorporated herein will be omitted in the case that the subject matter of the present disclosure may be rendered unclear thereby.

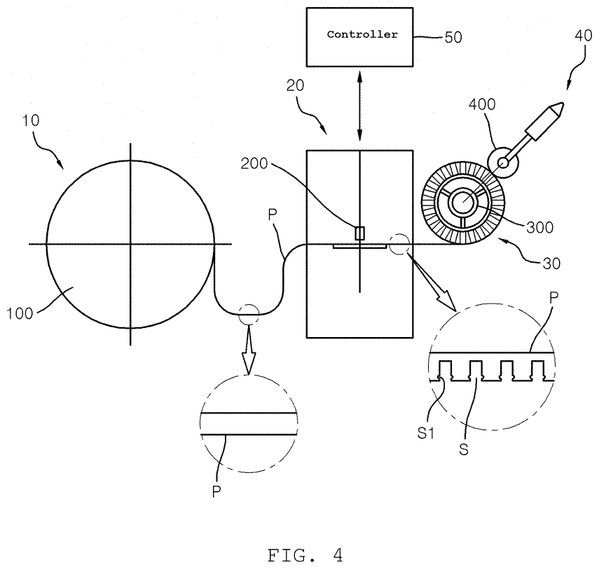

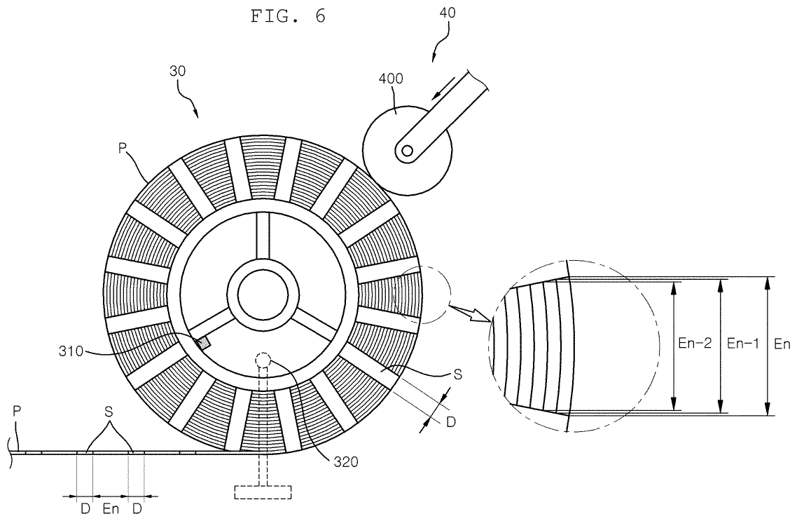

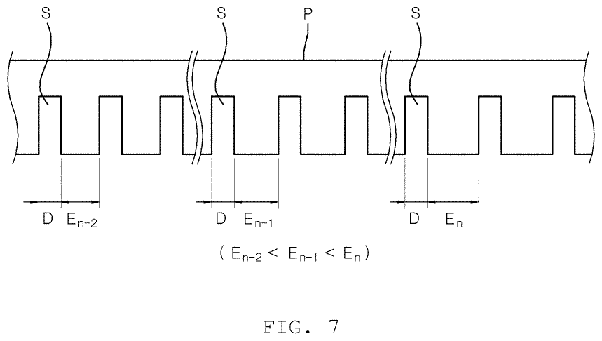

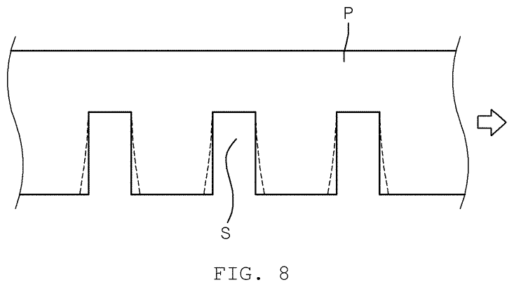

FIG. 4 is a conceptual view illustrating a configuration of an apparatus for fabricating a stator core of an axial motor for a traction machine according to exemplary embodiments, FIG. is a perspective view schematically illustrating a configuration of a rolling unit and a pressing unit according to exemplary embodiments, FIG. 6 is a side view illustrating a wound shape of the thin plate according to exemplary embodiments, FIG. 7 is a top view illustrating positions of the slots in the thin plate according to exemplary embodiments, and FIG. 8 is a top view illustrating deformations in the thin plate according to exemplary embodiments.

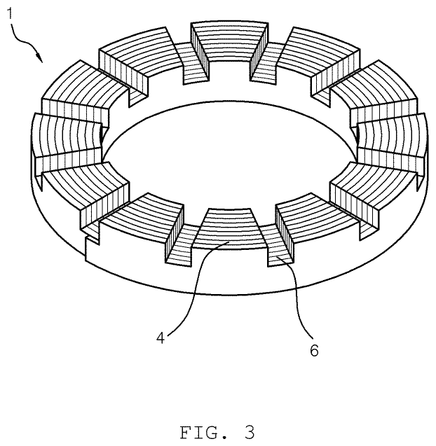

An apparatus for fabricating a stator core of an axial motor for a traction machine according to exemplary embodiments is an apparatus for fabricating a stator core by winding a thin plate P having open slots S such that the thin plate P is rolled and turns of the thin plate P are stacked on each other, as described above in the Background section with reference to FIG. 3. The apparatus includes a supply unit 10, a slot machining unit 20, a winding unit 30, a pressing unit 40, and a controller 50.

The supply unit 10 supplies the thin plate P made of a metal, wound in the form of a roll. As illustrated in FIG. 4, the supply unit 10 continuously supplies the thin plate P by operating a release roller 100.

The slot machining unit 20 continuously forms the open slots S in the thin plate P supplied by the supply unit 10 by machining, such that the open slots S are spaced apart from each other in the direction in which the thin plate P is supplied. The open slots S are formed to be open toward one edge of the thin plate P. The slot machining unit 20 may be configured to punch the thin plate P using a pressing unit 200.

The winding unit 30 receives the thin plate P from the slot machining unit 20 and winds the thin plate P around a winding roller 300 such that the thin plate P is rolled and the turns of the thin plate P are stacked on each other. The winding unit 30 performs the function of substantially moving the thin plate P while the thin plate P is being wound around the winding roller 300. That is, the thin plate P is released from the release roller 100 by traction generated by the winding unit 30 to pass through the slot machining unit 20 and then be wound around the winding roller 300.

The winding unit 30 may include the winding roller 300, around which the thin plate P is wound, and a drive motor (not shown) for rotating the winding roller 300. The thin plate P is moved and wound around the winding roller 300 by rotational driving force of the drive motor. Here, the pressing unit 200 of the slot machining unit 20 operates to punch the open slots S in predetermined periods. When the operating speed of the drive motor of the winding unit 30 is adjusted, the winding rotational speed of the winding roller 300 is adjusted, and the moving speed of the thin plate P is changed. In addition, pitches En of the open slots S continuously formed in the thin plate P are adjusted while the thin plate P is passing through the slot machining unit 20.

The pressing unit 40 operates to press the outer circumferential surface of the thin plate P, wound around the winding roller 300 of the winding unit 30, toward the center of the winding roller 300 using a pressing roller 400. Accordingly, it is possible to prevent the thin plate P from being deformed while the thin plate P is being wound around the winding roller 300, so that the open slots S can be aligned in lines in radial directions.

The controller 50 controls the operations of the supply unit 10, the slot machining unit 20, the winding unit 30, and the pressing unit 40. The controller 50 controls the operations of the corresponding components so that the open slots S of the thin plate P are aligned in the radial directions when the thin plate P is wound around the winding roller 300.

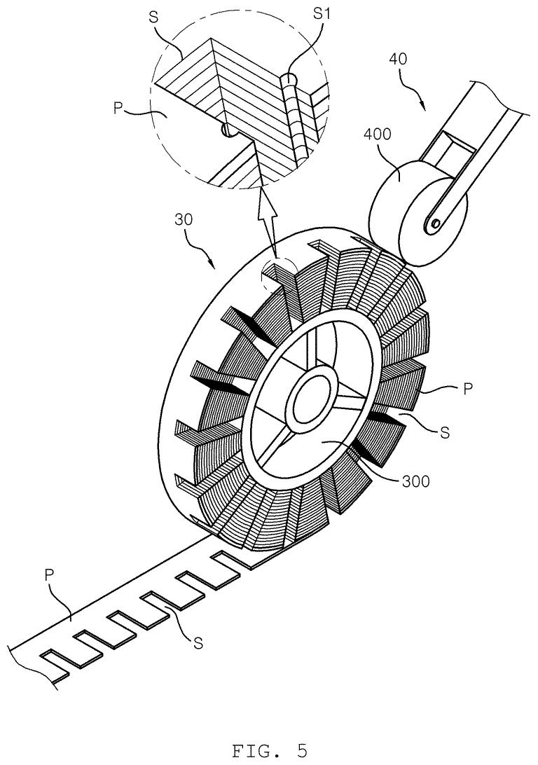

Described in more detail, as illustrated in FIGS. 5 and 6, the open slots S are formed in the thin plate P while the thin plate P, supplied by the supply unit 10, is passing through the slot machining unit 20. Afterwards, the thin plate P having the open slots is wound around the winding roller 300 of the winding unit 30, thereby forming a roll. Whenever one turn of the thin plate P is wound around the winding roller 300, the thickness of the layers of the rolled thin plate P increases by a value equal to the thickness of the thin plate P. Accordingly, the length (i.e. the circumferential length) of a single turn of the thin plate P increases, with increases in the number of turns of the thin plate P.

Here, the open slots S formed in the thin plate P must form mating surfaces aligned in the radial directions of the winding roller 300. In this regard, as illustrated in FIGS. 6 and 7, the pitches En of the open slots S of the thin plate P must be gradually reduced. Specifically, the pitches En of the open slots S must be gradually and sequentially reduced from the pitch of the open slots S in the outermost turn of the thin plate P to pitches En−1, En−2, . . . , and E1 of the open slots S in the inner turns of the thin plate P. Here, the widths D of the open slots S remain constant, punched by the same pressing unit 200.

In other words, whenever a single turn of the thin plate P is wound around the winding roller 300, the length of the turn of the thin plate P increases by a value equal to the thickness of the thin plate P, and the distances between the open slots S, i.e. the pitches En of the open slots S, gradually increase. Accordingly, when the thin plate P is wound around the winding roller 300, the open slots S are aligned in the radial directions.

According to exemplary embodiments, in order to wind the thin plate P as described above, the operation of the winding roller 300 is controlled so that the rotational speed of the winding roller 300 gradually increases at every rotation.

In this regard, as illustrated in FIG. 6, a rotation indicator 310 is attached to the winding roller 300 to indicate a winding start point of the thin plate P. A rotation sensor 320 is provided outside of the winding roller 300 to detect passing of the rotation indicator 310 when the winding roller 300 rotates. The controller 50 receives a detection signal of the rotation sensor 320 and controls the operation of the winding unit 30 so that the rotational speed of the winding roller 300 gradually increases at every rotation of the winding roller 300. It is possible to realize the rotational speed of the winding roller 300 by controlling the speed of the drive motor.

As the rotational speed of the winding roller 300 is increased at every rotation, the pitches of the open slots S of the thin plate P are gradually increased by the slot machining unit 20 operating at predetermined periods. Accordingly, the thin plate P wound around the winding roller 300 is rolled such that the open slots S are aligned in the radial directions.

However, while the thin plate P is being drawn by the winding roller 300, tension is created in the longitudinal direction, as illustrated in FIG. 8. In particular, portions of the thin plate defining the open slots S may be significantly deformed, due to relatively low strength thereof. The deformation may occur in a direction in which the open slots S are distorted or twisted.

When the thin plate P is deformed as described above, the thin plate P may not be uniformly wound around the winding roller 300 during winding, thereby causing a resultant product to be defective. For example, some sections of the thin plate P may be loose, or the open slots S may not be aligned.

According to exemplary embodiments, as described above, since the outer circumferential surface of the thin plate P is pressed using the pressing unit 40 in the process in which the thin plate P is wound around the winding roller 300, it is possible to prevent the thin plate P from being deformed, to align the open slots S in positions in the radial directions, and to maintain the uniformly wound state of the thin plate P.

After the thin plate P is wound as described above, a roll of the thin plate P is removed from the winding roller 300, and a welding operation or the like is performed to prevent the roll of the thin plate P from being unrolled. Afterwards, wire coils (not shown) are provided in the open slots S. To prevent the wire coils from being dislodged from the open slots S, stoppers (not shown) may be connected to distal ends of the open slots S. The slot machining unit 20 according to the present disclosure may form recesses S1 in both sides of the open slots S, such that the stoppers can be smoothly fitted into the open slots S.

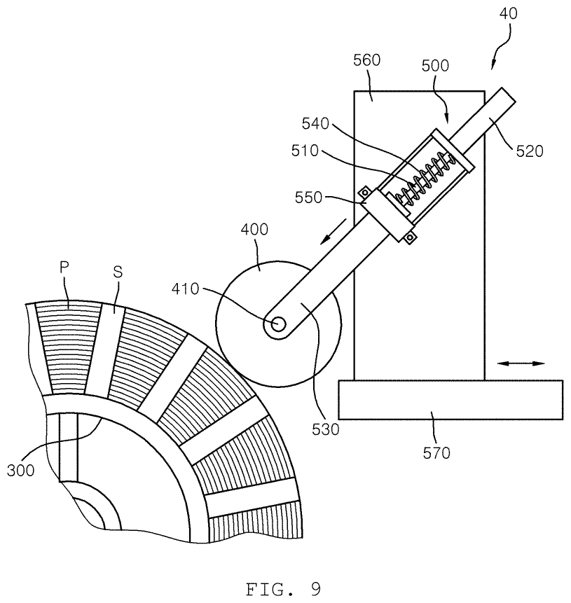

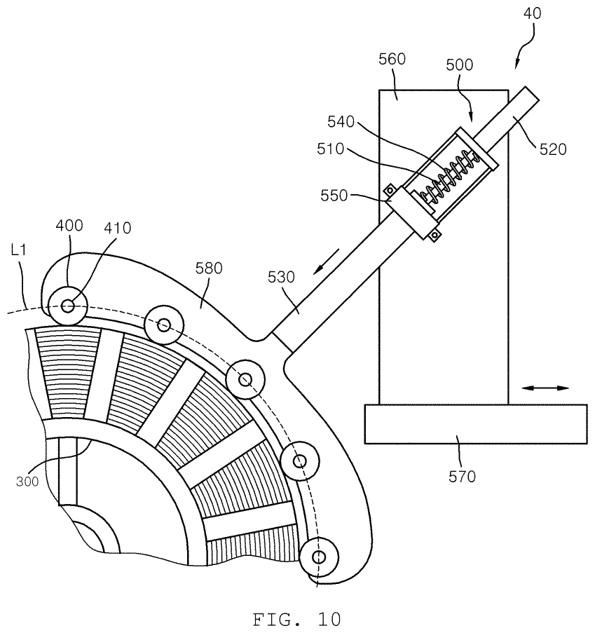

FIG. 9 is a side view schematically illustrating a configuration of an exemplary embodiment of the pressing unit, while FIG. 10 is a side view schematically illustrating a configuration of another exemplary embodiment of the pressing unit.

The pressing unit 40 according to an exemplary embodiment may include a pressing roller 400 in rolling contact with the outer circumferential surface of the thin plate P, which is being wound around the winding roller 300, and a pressurizing device 500 actuated by hydraulic or pneumatic pressure to press the pressing roller 400 against the thin plate P toward the center of the winding roller 300.

For example, the pressurizing device 500 may include a pressing rod 510 having one end connected to the pressing roller 400 and a pressurizing cylinder 520 linearly moving the pressing rod 510 using hydraulic or pneumatic pressure supplied by a pressure supply pump (not shown).

According to this structure, the hydraulic or pneumatic pressure of the pressurizing cylinder 520 actuates the pressing rod 510 in the direction in which the pressing roller 400 is pressed, so that the pressing roller 400 presses the thin plate P while in rolling contact with the outer circumferential surface of the thin plate P.

At this time, the thickness of the layers of the rolled thin plate P gradually increases as the winding roller 300 is being wound. In this case, when the pressurizing device 500 operates while maintaining the corresponding pressure, substantial pressing force increases with increases in the thickness of the layers of the rolled thin plate P. When the pressing force of the pressurizing device 500 excessively increases as described above, the pressurizing device 500 or the thin plate P may be damaged. To prevent this, the controller 50 can control the operation of the pressurizing device 500 such that the pressing force of the pressurizing device 500 is adjusted in response to increases in the number of turns of the thin plate P wound around the winding roller 300.

The control over the operation of the pressurizing device 500 may be variously modified as required by a user, in consideration of an initially set value of the pressing force. Alternatively, the operation of the pressurizing device 500 may be controlled to retain the operation of maintaining the pressure of the pressurizing device 500 at a constant value in order to simplify the control configuration.

In addition, the pressurizing device 500 may further include: an actuation block 530 linearly movable together with the pressing rod 510, with one end portion thereof being connected to a rotary shaft 410 of the pressing roller 400 and the other end portion thereof being connected to the pressing rod 510; and an elastic spring 540 applying elastic force to the actuation block 530 in the direction in which the pressing roller 400 is pressed.

Since the use of the elastic spring 540 to elastically press the pressing roller 400 can generate pressing force based on elastic force different from hydraulic or pneumatic force, hydraulic or pneumatic pressure may be set to be relatively low. In this case, the elastic spring 540 can buffer an increase in pressure due to the thickness of the layers of the rolled thin plate P or an impact due to an instantaneous increase in pressure or the like, which may occur during pressed rolling of the pressing roller 400. In addition, even in the case in which the operation of creating or providing hydraulic or pneumatic pressure malfunctions, it is possible to reliably maintain pressing force based on elastic force.

In this case, the actuation block 530 may be connected to a guide sleeve 550 such that the actuation block 530 linearly moves through the guide sleeve 550. The pressurizing cylinder 520 may be disposed on the guide sleeve 550. In addition, these components may be mounted on the basis of a baseplate 560. The baseplate 560 may be connected to a guide rail 570 to be linearly movable along the guide rail 570 in a direction in which the distance between the pressing roller 400 and the winding roller 300 is adjusted.

According to this configuration, the pressurizing device 500 can linearly move so that the distance between the pressing roller 400 and the winding roller 300 is adjusted. Accordingly, after winding of the thin plate P around the winding roller 300 has been completed, when the thin plate P is intended to be unwound from the winding roller 300, pressing force on the thin plate P may be completely released by moving the pressurizing device 500 and the operation of unwinding the thin plate P may be performed. Accordingly, it is possible to more easily unwind the thin plate P.

In addition, as illustrated in FIG. 10, the pressing unit 40 according to another exemplary embodiment may include a plurality of pressing rollers 400, and the pressurizing device 500 may further include a roller guide frame 580 to which the plurality of pressing rollers 400 are rotatably mounted. Here, the plurality of pressing rollers 400 may be mounted to the roller guide frame 580 such that rotary shafts 410 thereof are disposed on a circular line L1 concentric with the winding roller 300.

In this case, the pressurizing device 500 may be configured such that one end of the roller guide frame 580 is connected to the actuation block 530. Accordingly, the plurality of pressing rollers 400 can be simultaneously pressurized via the roller guide frame 580.

Since a plurality of portions of the outer circumferential surface of the thin plate P are pressed using the plurality of pressing rollers 400, it is possible to more completely prevent the thin plate P from being deformed, thereby further reducing a defect ratio in fabrication.

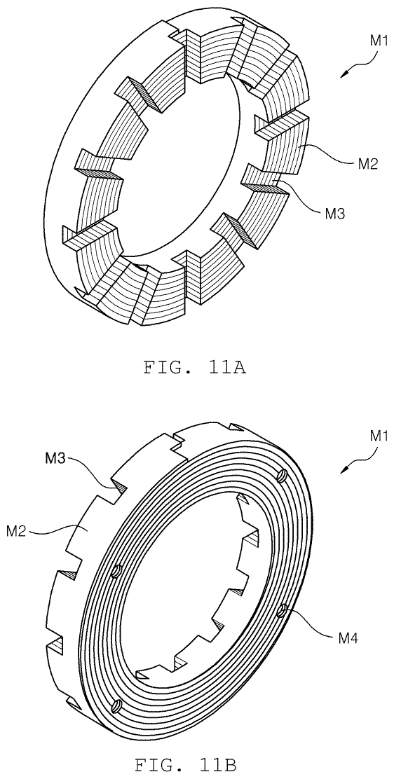

FIGS. 11A and 11B are perspective views schematically illustrating a configuration of a stator core fabricated by the fabrication apparatus according to exemplary embodiments.

As illustrated in FIGS. 11A and 11B, a stator core M1 fabricated using the fabrication apparatus according to exemplary embodiments as described above is provided as a roll of a thin plate, with turns of the thin plate being stacked on each other. Here, since open slots are provided in the thin plate, protrusions M2 protruding from one surface of the stator core M1 and recesses M3 depressed into the one surface of the stator core M1 continuously alternating with each other in the circumferential direction.

In general, the stator core M1 having such a configuration is disposed inside of a motor housing (not shown) via a baseplate (not shown) fixed to the other surface of the stator core M1. In the axial motor for a traction machine according to exemplary embodiments, the stator core M1 is provided with a plurality of tap-holes in the other surface opposite to one surface in which the open slots (defining the protrusions M2 and the recesses M3) are formed.

According to this configuration, material costs and fabrication costs can be reduced, since a separate baseplate is unnecessary. In addition, efficiency can be improved, since eddy loss due to the baseplate is reduced. A heat dissipation effect can be improved. It is possible to advantageously manage and maintain error gaps, due to reduced cumulative errors. Any deformation that would occur during welding can be prevented, since it is unnecessary to weld the baseplate.

The foregoing descriptions have been presented in order to explain certain principles of the present disclosure by way of example. A person skilled in the art to which the present disclosure relates could make various modifications and variations without departing from the essential features of the present disclosure. The foregoing embodiments disclosed herein shall be interpreted as being illustrative, while not being limitative, of the principle and scope of the present disclosure. It should be understood that the scope of the present disclosure shall be defined by the appended Claims and all of their equivalents fall within the scope of the present disclosure.

1. An apparatus for fabricating a stator core of an axial motor for a traction machine, the apparatus comprising:
a supply unit supplying a thin plate made of a metal and wound in a roll;
a slot machining unit machining open slots in the thin plate supplied by the supply unit, such that the slots are open toward an edge of the thin plate and are spaced apart from each other in a direction in which the thin plate is supplied;
a winding unit receiving the thin plate from the slot machining unit and winding the thin plate around a winding roller such that the thin plate is rolled and turns of the thin plate are stacked on each other;
a pressing unit pressing an outer circumferential surface of the thin plate, which is wound around the winding roller, toward a center of the winding roller; and
a controller controlling operations of the supply unit, the slot machining unit, the winding unit, and the pressing unit such that the open slots of the thin plate are aligned in radial directions when the thin plate is wound around the winding roller.

2. The apparatus according to claim 1, wherein the pressing unit comprises:
a pressing roller in rolling contact with the outer circumferential surface of the thin plate, which is wound on the winding roller; and
a pressurizing device actuated by hydraulic or pneumatic pressure to press the pressing roller in a direction of a center of the winding roller.

3. The apparatus according to claim 2, wherein the controller controls an operation of the pressurizing device such that pressing force of the pressurizing device is adjusted in response to increases in the number of turns of the thin plate wound around the winding roller.

4. The apparatus according to claim 2, wherein the pressurizing device comprises:
a pressing rod having one end connected to the pressing roller; and
a pressurizing cylinder linearly moving the pressing rod using hydraulic or pneumatic pressure supplied by a pressure supply pump.

5. The apparatus according to claim 4, wherein the pressurizing device comprises:
an actuation block linearly movable together with the pressing rod, with one end portion thereof being connected to a rotary shaft of the pressing roller and the other end portion thereof being connected to the pressing rod; and
an elastic spring applying elastic force to the actuation block in the direction in which the pressing roller is pressed.

6. The apparatus according to claim 2, wherein the pressurizing device is linearly movably disposed such that a distance between the pressing roller and the winding roller is adjustable.

7. The apparatus according to claim 2, wherein the pressing roller comprises a plurality of pressing rollers,
the pressurizing device further comprises a roller guide frame to which the plurality of pressing rollers are rotatably coupled, such that the plurality of pressing rollers are coupled to the roller guide frame such that rotary shafts thereof are disposed on a circular line concentric with the winding roller, and
the pressurizing device simultaneously pressurizes the plurality of pressing rollers via the roller guide frame.

8. The apparatus according to claim 1, wherein the slot machining unit forms the open slots in the thin plate by machining such that recesses are formed in both sides of the open slots.

9. The apparatus according to claim 1, further comprising:
a rotation indicator attached to the winding roller to indicate a winding start point of the thin plate; and
a rotation sensor provided outside of the winding roller to detect passing of the rotation indicator when the winding roller rotates,
wherein the controller receives a detection signal of the rotation sensor and controls the operation of the winding unit so that a rotational speed of the winding roller gradually increases at every rotation of the winding roller.

10. A method of fabricating a stator core of an axial motor for a traction machine, the method comprising:
supplying a thin plate made of a metal and wound in a roll;
machining open slots in the thin plate supplied by the supply unit, such that the slots are open toward an edge of the thin plate and are spaced apart from each other in a direction in which the thin plate is supplied;
receiving the thin plate having the open slots and winding the thin plate around a winding roller such that the thin plate is rolled and turns of the thin plate are stacked on each other; and
pressing an outer circumferential surface of the thin plate, which is wound around the winding roller, toward a center of the winding roller using a pressing roller,
wherein an operation of the winding roller is controlled such that a winding rotational speed of the winding roller gradually increases at every rotation.

11. An axial motor for a traction machine comprising the stator core fabricated using the apparatus as claimed in claim 1, the stator core being disposed inside of a motor housing,
wherein the stator core comprises a roll of the thin plate having the open slots, with the turns of the thin plate being stacked on each other, and
a plurality of tap-holes are provided in a surface of the stator core opposite to the open slots, such that the stator core is connected to the motor housing using bolts fitted into the tap-holes.
